(19) United States
(12) Patent Application Publication
(10) Pub. No.: US 2008/0123519 A1
(43) Pub. Date: May 29, 2008

(54) METHOD AND APPARATUS FOR REMOVING MEMBER OF LCAS FROM SINK AND STATE MACHINE AT SINK

(75) Inventors: Yang YANG, Shenzhen (CN); Zhiguang ZHAO, Shenzhen (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: HUAWEI TECHNOLOGIES CO., LTD., Shenzhen (CN)

(21) Appl. No.: 11/848,598

(22) Filed: Aug. 31, 2007

Related U.S. Application Data
(63) Continuation of application No. PCT/CN2006/000301, filed on Mar. 1, 2006.

(30) Foreign Application Priority Data
Mar. 1, 2005 (CN) 200510033434.2

(51) Int. Cl. G06F 11/00

(52) U.S. Cl. 370/216

(57) ABSTRACT

A method for removing a member of a Link Capacity Adjustment Scheme (LCAS) from a sink includes: notifying, by the sink, a source that a member is in a REMOVE state after receiving a remove command; determining, by the sink, whether a notification response is received; if the notification response is not received, keeping the member in the REMOVE state, keeping reading payload from the member, and waiting for the notification response; if the notification response is received, moving the member to an IDLE state. Embodiments of the present invention also provide an apparatus and a state machine at the sink. A REMOVE state at the sink is added for each member. The method and the state machine provided by embodiments of the present invention guarantee a synchronous modification of the bandwidth at the source and the sink, thereby guaranteeing no hit on the traffic.

This application is a continuation of International Patent Application No. PCT/CN2006/000301, filed Mar. 1, 2006, which claims priority to Chinese Patent Application No. 200510033434.2, filed Mar. 1, 2005, both of which are hereby incorporated by reference.

### FIELD OF THE INVENTION

The present invention relates to communication technologies, and more particularly, to a method and an apparatus for removing a member of a Link Capacity Adjustment Scheme (LCAS) from a sink and a state machine at the sink.

### BACKGROUND OF THE INVENTION

LCAS, defined by International Telecommunications Union Telecommunication Standardization Sector (ITU-T) in G.7042, provides a negotiation mechanism between Virtual Concatenation Group (VCG) source and sink to guarantee that there is no hit to traffic when a member is added to or removed from the sink, thereby implementing hitless bandwidth modification.

Establishment or release of a Virtual Concatenation (VC) and addition or removal of a member are achieved by changing a field of a control packet and establishing a negotiation process between the source and the sink. The control packet describes the state of the VC link and ensures synchronization of changes in network between the source and the sink. The control packet mainly includes the following fields:

1. Member Status (MST) field, sent from the sink to the source, used to convey status of the members of the VC;

2. Re-Sequence Acknowledge (RS-Ack) bit, sent from the sink to the source, used for transferring a change of the sequence of the members detected by the sink;

3. Control (CTRL) field, sent from the source to the sink, used to synchronize the sink with the source and provide the status of the member of the VCG;

4. Group Identification (GID) bit, used for identification of the VCG;

5. Cyclic Redundancy Check (CRC) field, used to protect the control packet.

For each member in the VCG, there is a state machine at the source and a state machine at the sink. The state machine at the source includes five states: IDLE, NORM, DNU (Do Not Use), ADD and REMOVE. The state machine at the sink includes three states: IDLE, OK and FAIL; wherein if an incoming signal for the member experiences no failure condition or has received and acknowledged a request for addition of the member, the member is in the OK state; if the incoming signal for the member experiences a failure condition or an incoming request for removal of the member has been received and acknowledged, the member is in the FAIL state.

In G.7042, for the purpose of guaranteeing no hit to the traffic, the LCAS requires that the addition or removal of a member should be initiated at the source. The detailed implementation is described in the related standards. Because the addition or removal of the member at the source is not related to the present invention, it will not be described herein. As to the addition or removal of the member initiated at the sink, the state machine at the sink defined by the G.7042 cannot ensure that no hit to the traffic and hitless modification of the bandwidth.

FIG. 1 is a schematic diagram illustrating a negotiation procedure of the removal of a member initiated at the sink defined by the prior art G.7042. As shown in FIG. 1, when a member in the OK state receives a remove command M_{REMOVE} from a Network Management System (NMS), the sink sends MST=FAIL to the source, and stops reading payload from the member. The state of the member moves to the IDLE state. Thus, the member is removed.

When the NMS initiates the removal of the member at the sink, the negotiation procedure of the state machine at the sink includes:

1) After receiving the M_{REMOVE} from the NMS, the sink sends MST=FAIL to the source;

2) From the beginning of next multiframe, the sink stops reading payload from the member and moves the member to the IDLE state, i.e., the member is removed.

It should be noted that the part circled by dotted lines in FIG. 1, i.e., the state machine of the removal of the member, is what is related to the present invention. Other parts are the same as those defined in the G.7042 and are not described herein.

The corresponding negotiation procedure of the state machine at the source defined in the G.7042 includes:

1) The source retrieves the MST=FAIL;

2) Change CTRL=DNU, i.e., indicate that the state of the member is moved from the NORM state to the DNU state at the source;

3) From the beginning of the next multiframe, the source stops sending payload to the member.

In the above negotiation procedure diagram, the MST=FAIL sent by the sink will not be acquired by the source until 64 ms/128 ms elapses. Supposing that a time interval from the sink sending the MST=FAIL to stopping reading payload from the member is t_{Rx}, a time interval from the source acquiring the MST=FAIL to the member moving to the DNU state is t_{Tx}. If the time when the source stops sending payload differs from the time when the sink stops reading payload, for example, t_{Rx} is smaller or larger than t_{Tx}+64 ms/128 ms, there will be hit to the traffic. Moreover, the t_{Rx} and t_{Tx} for each sink or source are different. Therefore, with the state machine at the sink defined by the G.7042, it cannot be guaranteed no hit on the traffic when the sink initiates the removal of the member, and thus cannot guarantee the hitless modification of the bandwidth.

### SUMMARY OF THE INVENTION

The present invention provides a method and an apparatus for removing a member of a Link Capacity Adjustment Scheme (LCAS) from a sink, to guarantee no hit to traffic when a sink initiates the removal of the member.

The present invention also provides a state machine at the sink for implementing removal of a member initiated by a sink, to guarantee no hit to the traffic when the sink initiates the removal of the member.

The method for removing a member of the LCAS from the sink includes:

notifying, by the sink, a source that a member to be removed is in a REMOVE state after receiving a remove command; and

determining, by the sink, whether a notification response from the source is received; if the notification response is not received, keeping the member in the REMOVE state, keeping reading payload from the member and waiting for the notification response; if the notification response is received, moving the member to an IDLE state.

A state machine at a sink of a Link Capacity Adjustment Scheme (LCAS) for implementing removal of a member initiated by the sink includes: an IDLE state, a traffic carry state OK, a FAIL state, and a REMOVE state, wherein the sink waits for a notification response from a source for acknowledging removal of a member at the REMOVE state, and keeps reading payload from the member.

An apparatus for removing a member of a Link Capacity Adjustment Scheme (LCAS) from a sink includes:

a unit, adapted for notifying a source that a member is in a REMOVE state after receiving a remove command; and determining whether a notification response from the source is received; if the notification response is not received, keeping the member in the REMOVE state, keeping reading payload from the member, and waiting for the notification response; if the notification response is received, moving the member to an IDLE state.

An apparatus for removing a member of a Link Capacity Adjustment Scheme (LCAS) from a sink includes:

a unit, adapted for receiving a notification from a sink notifying that a member is in a REMOVE state and sending a notification response to the sink.

In the present invention, a state for indicating that a member is in the remove process, i.e., a REMOVE state, is added to the state machine at the sink defined by the G.7042. In the REMOVE state, the sink waits for the notification response from the source and keeps reading payload from the member. The sink stops reading payload from the member from beginning of a next multiframe after receiving the notification response.

The method, apparatus and state machine provided by the present invention guarantee a synchronous modification of the bandwidth at the source and the sink, thereby guaranteeing no hit to the traffic.

### BRIEF DESCRIPTION OF THE DRAWINGS

FIG. 1 is a schematic diagram illustrating a negotiation procedure of the removal of a member initiated at the sink defined by the G.7042 according to the related art.

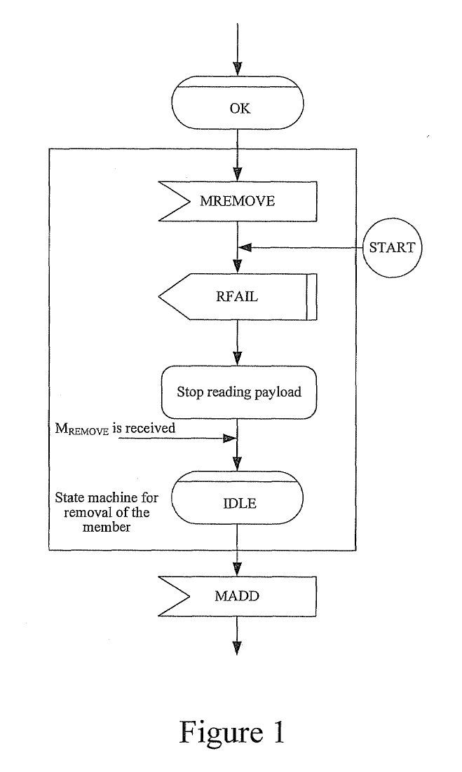

FIG. 2 is a schematic diagram illustrating a negotiation procedure of removal of a member initiated at the sink according to an embodiment of the present invention.

### EMBODIMENTS OF THE INVENTION

The present invention is described in detail as follows with reference to accompanying drawings and embodiments.

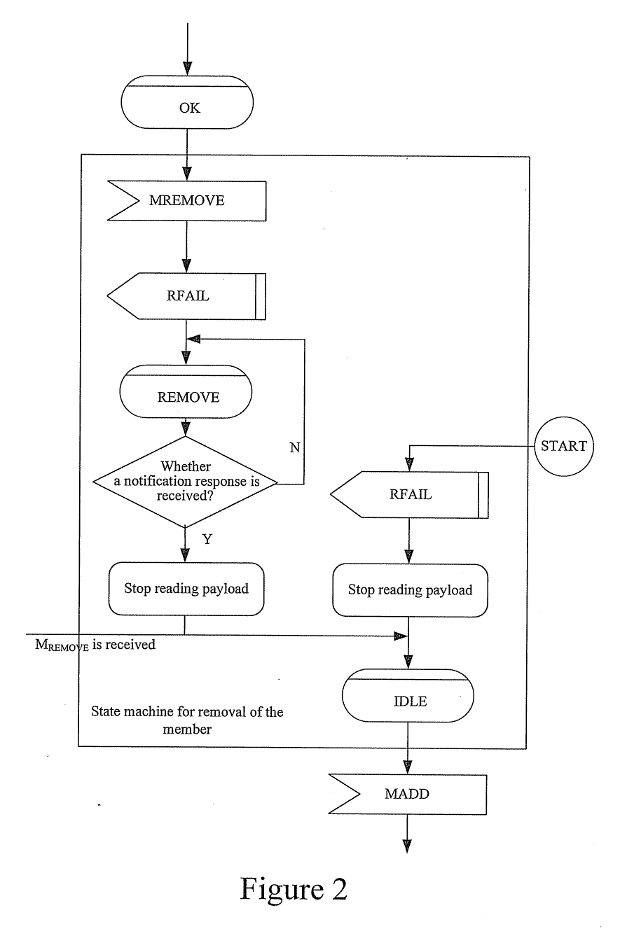

FIG. 2 is a schematic diagram illustrating a negotiation procedure of removal of a member initiated at the sink according to an embodiment of the present invention. In the OK state, the sink receives a remove command M_{REMOVE} from the NMS or the source or other management devices. The sink notifies the source that the member to be removed moves into the REMOVE state, and determines whether a notification response is received from the source. If the notification response is not received, the sink keeps the member in the REMOVE state and keeps reading payload from the member and waits for the notification response. If the notification response is received, the sink moves the member to the IDLE state. The negotiation procedure specifically includes:

a) The sink sends an MST=FAIL to the source to notify the source to change the state of the member at the source, and moves the state of the member at the sink from the OK state to the REMOVE state;

b) After retrieving the MST=FAIL, the source signals CTRL=DNU to move the member from the NORM state to the DNU state, and sends the CTRL=DNU to the sink;

c) From the beginning of the next multiframe, the sink stops reading payload from the member after receiving the CTRL=DNU;

d) The sink moves the member from the REMOVE state to the IDLE state to indicate that the member is removed successfully.

At the source, from the next multiframe after signaling the CTRL=DNU, the source stops sending payload to the member. At the sink, from the next multiframe after receiving the CTRL=DNU, the sink stops reading payload from the member. Thus, a synchronous modification of the bandwidth at the source and the sink may be guaranteed, thereby guaranteeing no hit on the traffic.

It should to be noted that the part circled by dotted lines in FIG. 2, i.e., the state machine of the removal of the member, is what is related to the present invention. Other parts are the same as those defined in the G.7042 and are not described herein.

Further, when the sink waits for the notification response from the source, if the sink detects failure of the member, the sink stops reading payload from the member at once and removes the member from the sink. Or, when the member is in the NORM state, the sink determines whether to remove the member according to the CTRL field sent by the source. For example, the sink determines to remove the member if CTRL=DNU/ADD/IDLE is received.

The foregoing description is only the preferred embodiments of the present invention and is not for limiting the protection scope of the present invention. All the modifications, equivalent replacements or improvements within the principle of the present invention shall be covered under the protection scope of the present invention.

What is claimed is:

1. A method for removing a member of a Link Capacity Adjustment Scheme (LCAS) from a sink, comprising:
notifying, by a sink, a source that a member is in a REMOVE state after receiving a remove command; and
determining, by the sink, whether a notification response from the source is received; if the notification response is not received, keeping the member in the REMOVE state, keeping reading payload from the member, and waiting for the notification response; if the notification response is received, moving the member to an IDLE state.

2. The method of claim 1, wherein the notifying the source that the member is in the REMOVE state after receiving a remove command comprises:
sending, by the sink, a Member Status (MST)=FAIL to the source; and
moving, by the sink, the member from a OK state to the REMOVE state.

3. The method of claim 1, wherein the notification response comprises any one of CTRL=Do Not Use (DNU), CTRL=ADD and CTRL=IDLE.

4. The method of claim 1, further comprising:
stopping, by the sink, reading payload from the member from beginning of a next multiframe after receiving the notification response from the source.

5. The method of claim 1, further comprising:
stopping, by the sink, reading payload from the member after moving the member to an IDLE state.

6. The method of claim 1, further comprising:
stopping waiting for the notification response if a failure of the member is detected.

7. The method of claim 5, further comprising:
removing, by the sink, the member after stopping reading payload from the member.

8. A state machine at a sink of a Link Capacity Adjustment Scheme (LCAS) for implementing removal of a member initiated by the sink, comprising:
an IDLE state, a traffic carry state OK, a FAIL state; and
a REMOVE state, where the sink waits for a notification response from a source for acknowledging removal of a member, and keeps reading payload from the member.

9. The state machine of claim 8, wherein in the REMOVE state, the sink stops reading payload from the member from beginning of a next multiframe after receiving the notification response from the source.

10. An apparatus for removing a member of a Link Capacity Adjustment Scheme (LCAS) from a sink, comprising:
a unit, adapted for notifying a source that a member is in a REMOVE state after receiving a remove command; and determining whether a notification response from the source is received; if the notification response is not received, keeping the member in the REMOVE state, keeping reading payload from the member, and waiting for the notification response; if the notification response is received, moving the member to an IDLE state.

11. The apparatus of claim 10, wherein the unit is further adapted for sending a Member Status (MST)=FAIL to the source; and moving the member from a OK state to the REMOVE state.

12. The apparatus of claim 10, wherein the unit is further adapted for stopping reading payload from the member from beginning of a next multiframe after receiving the notification response from the source.

13. The apparatus of claim 10, wherein the unit is further adapted for stopping reading payload from the member after moving the member to an IDLE state.

14. The apparatus of claim 10, wherein the unit is further adapted for stopping waiting for the notification response if a failure of the member is detected.

15. The apparatus of claim 13, wherein the unit is further adapted for removing the member after stopping reading payload from the member.

16. An apparatus for removing a member of a Link Capacity Adjustment Scheme (LCAS) from a sink, comprising:
a unit, adapted for receiving a notification from a sink notifying that a member is in a REMOVE state and sending a notification response to the sink.

17. The apparatus of claim 16, wherein notification received from sink comprises a Member Status (MST)=FAIL.

18. The apparatus of claim 16, wherein the notification response comprises any one of CTRL=Do Not Use (DNU), CTRL=ADD and CTRL=IDLE.
